(19) United States
(12) Patent Application Publication
(10) Pub. No.: US 2013/0117786 A1
(43) Pub. Date: May 9, 2013

(54) SOCIAL NETWORK CONTENT DRIVEN ELECTRONIC PROGRAM GUIDE

(71) Applicants: Richard Martin Hofer, Aurora, CO (US); Michael Andrew Michuda, Denver, CO (US)

(72) Inventors: Richard Martin Hofer, Aurora, CO (US); Michael Andrew Michuda, Denver, CO (US)

(73) Assignee: Dish Network L.L.C., Englewood, CO (US)

(21) Appl. No.: 13/289,942

(22) Filed: Nov. 4, 2011

(51) Int. Cl. H04N 21/482

(52) U.S. Cl. 725/40

(57) ABSTRACT

The present disclosure introduces a Social Network Content Driven Electronic Program Guide (EPG). In one embodiment, the computer program language when executed by a processor performs operations that allow a user to specify whether media content information presented by an EPG is presented within a context of multiple contexts of one or more social network(s) and corresponding social circle(s) associated with the user. Responsive to the user indicating that the EPG present media content within a particular one context of the multiple contexts, the EPG edits any context intersecting media content information with associated information from the social network to personalize the media content information. The edited content is then highlighted and presented by the EPG. All other media content information is presented without highlights. Other embodiments are also described.

### BACKGROUND

Viewers have an ever-increasing number of broadcast and TV programming and on-demand selections from which to choose. To select media of interest, broadcast and on-demand TV viewers will typically use an Electronic Program Guide (EPG). EPGs are computer software programs provided by cable or satellite providers to subscribers. An EPG provides users of television, computers, radio, and other media content presentation applications with menus displaying scheduling and channel information for current and upcoming programming A modern form of the EPG is called an Interactive Program Guide (IPG or interactive EPG). Interactive EPGs allow television viewers and radio listeners to navigate scheduling information menus interactively, selecting and discovering programming by title, time, genre, or station using an input device such as a keypad, a TV remote control, a computer keyboard, etc.

Current state of the art interactive EPG applications (hereinafter also referred to as an “EPG”) are grid program content guides—providing an ability to break/sort these many channels down into categories (HD, SD, personal folders (adult, children, individuals, a house, etc.)). Data to populate an EPG may be distributed over the Internet and implemented on equipment connected directly or through a computer to the Internet. Television-based EPGs combined with Program Delivery Control (PDC) technology can allow end users to select programs to record with Digital Video Recorders (DVRs).

For a viewer to decide whether a program will be of interest, the viewer typically depends on the information provided by the EPG. Such information includes, for example, plot description, cast member lists, rating information, scheduling, and/or other basic information about the media content. Often, however, this information is often not enough for the viewer to make a decision on whether the program is of interest to the viewer.

Collaborative Filtering Systems (CFSs) try to address this need by estimating the particular media a user would like. CFSs use viewing choices from other people to determine whether someone similar may be interested in a particular piece of media content. Collaborative filtering systems can generally be reduced to two steps: (1) find users who share the same rating patterns with the active user for whom the prediction is directed; and (2) utilize the ratings from those like-minded users found in step one to calculate a prediction for the active user. Unfortunately, relying on a scoring or rating system that is averaged across all users that do not know one another and may not have common interests ignores specific demands of a user. This technique is particularly poor in tasks where there is large variation in interest, for example in recommending media content such as a movie, music, or a game.

### SUMMARY

The present disclosure introduces a Social Network Content Driven Electronic Program Guide (EPG). In one embodiment, a computer program language when executed by a processor performs operations that allow a user to specify whether media content information presented by an EPG is presented within a context of multiple contexts of one or more social network(s) and corresponding social circle(s) associated with the user. Responsive to the user indicating that the EPG present media content within a particular one context of the multiple contexts, the EPG edits any context intersecting media content information with associated information from the social network to personalize the media content information. The edited content is then highlighted and presented by the EPG. All other media content information is presented without highlights. Other embodiments are also described.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Various embodiments will now be described in detail with reference to the accompanying drawings.

FIG. 1 is an exemplary view of an environment for Social Network Content Driven Electronic Program Guides, according to an example embodiment.

FIG. 2 shows an exemplary user interface for a Social Network Content Driven EPG with the “What's on Now” social network filter/context having been selected by a user, according to one embodiment.

FIG. 3 shows an exemplary user interface for a Social Network Content Driven EPG with the “My Social” social network filter having been selected by a user, according to one embodiment.

FIG. 4 shows an exemplary user interface for a Social Network Content Driven EPG with the “Everything” social network filter having been selected by a user, according to one embodiment.

FIG. 5 shows the exemplary procedure for a Social Network Content Driven EPG, according to one embodiment.

### DETAILED DESCRIPTION

The following detailed description is divided into four sections. A first section provides a brief overview of the Social Network Content Driven Electronic Program Guide. A second section presents exemplary embodiments of Social Network Content Driven Electronic Program Guides. The third section details exemplary methods for Social Network Content Driven Electronic Program Guides. Furthermore, the final section presents the claims

### Overview

There is a general desire to tie and browse socially driven content within an electronic program guide (EPG). Right now, there is very little connection between an EPG and social network content of a viewer. Current state of the art EPG applications are grid program content guides that provide and an ability for a user to break or sort these many channels down into categories. None of these filters today are socially driven. In contrast to such conventional EPGs, the systems and methods described herein include a Social Network Content Driven EPG filter.

The following described Social Network Content Driven EPG is useful in a variety of applications such as media content delivery over cable, satellite communications, wireless base stations, and set top boxes. Social content fits easily within the EPG context within social circles. For example, friends and family interact with multimedia content in the social space. Maybe an actor has a social page or a director does. The described systems and methods identify this and other information via an Application Programming Interface (API) exposed by the social network application and integrates it into the grid EPG experience. This allows an EPG user to interact with the EPG Grid contents based on what their social circle is doing and based on their personal experience. These systems and methods allow users to import their social network content into the EPG for browsing and assisting with decisions of what media to select.

When a user displays a Social Network Content Driven EPG on a display device, the user has an option to use the EPG with or without the social network content driven information. If the user uses the EPG with social network content driven information, the EPG allows that user to display the social content in alternate ways or contexts. For example, alternate ways or contexts to display social information within the context of EPG media content information includes for example, (1) Everything; (2) What's on Now; and (3) My Social Content/Guide. In these scenarios, the only content that is highlighted on display is content/connected channel information that are in the user's social circle within the user selected context. The goal is for the invention to be completely socially driven by all social networks or one social network. For example, option (1) “Everything” is graphically brought to the user's attention differently than options (2) What's on Now; and (3) My Social. Option (3) “My Social” is personal—“I like Tom Cruise” in a Social Network highlight displays Tom Cruise content in the Social Network Content Driven EPG.

Further aspects of exemplary environments for Social Network Content Driven EPGs and various implementations of Social Network Content Driven EPGs are now described in greater detail.

### An Exemplary System

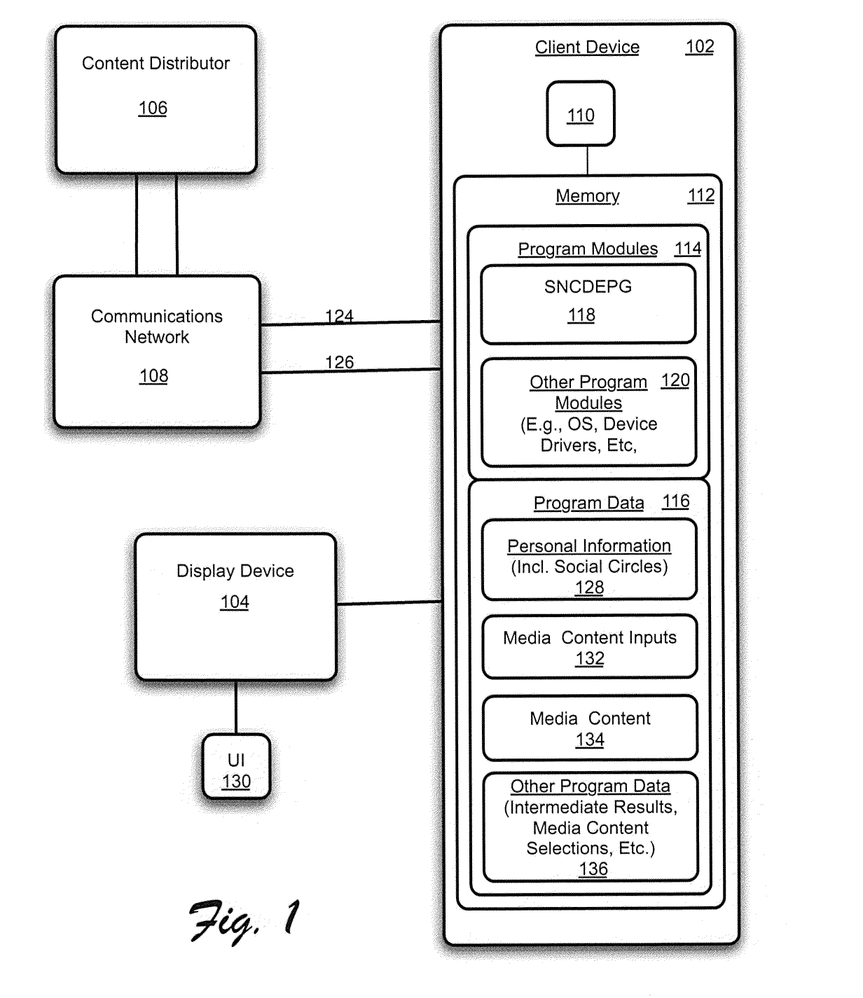

FIG. 1 is a view of an exemplary system 100 for a Social Network Content Driven Electronic Programming Guide, according to an example embodiment. In this embodiment, system 100 includes any number of client device(s) 102, a display device 104 and a content distributor 106. Each of these devices is operatively coupled to once another via communications network 108. The client device 102 and the display device 104 are examples of devices that can render audio, video, and/or image data. The client device, for example, is one or a combination of a television set-top box, a digital video recorder (DVR) and playback system, a portable computing device, and appliance device, a gaming device, and/or any other type of television client device that can be implemented in a television entertainment and information system. The display device 104 is any type of display system such as an LCD, a TV screen, a projection movie screen, and/or so on.

In this example, client device 102 comprises one or more processors 110 (e.g., microprocessor(s), controller(s), etc.) operatively coupled to system memory 112. System memory 112 includes various computer-readable media, such as volatile memory (e.g., random access memory (RAM)) and/or nonvolatile memory (e.g., read-only memory (ROM)). System memory also includes computer-program modules 114 and program data 116. In this implementation, processor(s) 110 implement computer-program instructions of respective computer program modules 114 to provide Social Network Content Driven EPG to an end user. In this implementation, program modules include Social Network Content Driven EPG module 118 (i.e., “SNCDEPG 118” in FIG. 1), and “other program modules” 120 such as an operating system, device drivers, and/or so on. Social Network Content Driven EPG module 118 is configured to communicate with one or more content distributors 106 over Internet 124 and/or communication network 108. Internet 124 can be implemented as part of the communication network 108 that facilitates media content distribution and data communication between the content distributors 106 and any number of client device(s) 102. The communication network 108 can be implemented as part of a media content distribution system using any type of network topology and/or communication protocol, and can be represented or otherwise implemented as a combination of two or more networks.

Social Network Content Driven EPG 118 is configured to interface with any of the active Social Networks available on the Internet (of which there are hundreds) to determine what a user of the client device 102 is interested in. In this exemplary implementation, client device 102 as well as the Social Network Content Driven EPG 118 can communicate data, e.g., to the content distributor 106, via a data communication link 126 of the communication network 108. In this implementation, one or more of the communication links 124 and 126 facilitate two-way data communication between the client device 102 in the recipient (e.g., the content distributor 106), and vice versa.

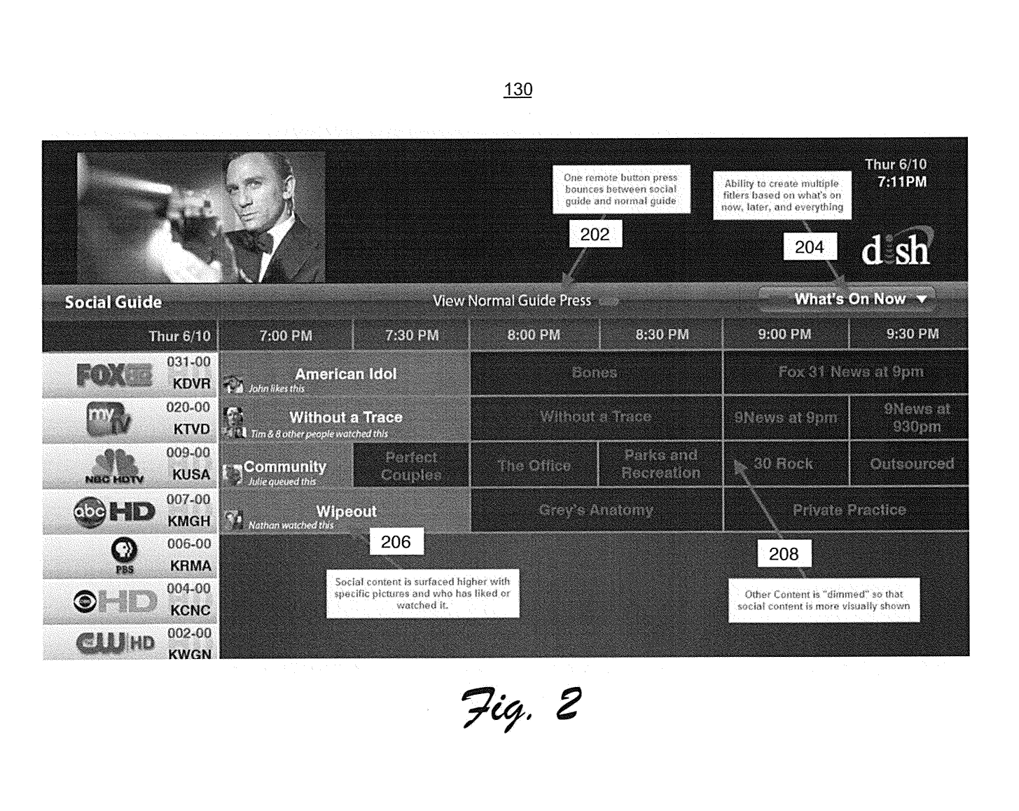

In one implementation, a user may interface with the Social Network Content Driven EPG 118 to indicate personal information 128 to access to various social networks of interest. Such personal information includes, for example, social network name(s) and/or address(es), user name(s), password(s), interests, etc. In this implementation, the Social Network Content Driven EPG 118 uses the personal information 128 to identify the social circles associated with the user. Social circles are groups of socially interconnected people. In this exemplary implementation, a person's social circle(s) are stored in personal information 128. In another embodiment, other interfaces are used, based on the API exposed by the social network, to determine if a user is associated with a particular set of social network(s) and to identify the corresponding user social circle(s). Then Social Network Content Driven EPG 118 identifies the media content information mentioned/discussed/presented, etc., as an object of interest in the identified social networks for selective display on a user interface (UI) 130 (on command). UI 130 is described in greater detail below in reference to FIGS. 2 through 4.

Social Network Content Driven EPG 118 is configured to interface with an identified social network to locate the media content of interest to the user's social circle 128 so that corresponding information can be presented to the user on command in a user interface (UI) 130. In one implementation, this is done automatically at configurable periodic time intervals. In another implementation, this is done when the user indicates that the EPG is to be supplemented with the user's specified/selected social content. In another implementation, it is done both ways, and/or etc.

Referring to FIG. 1, media content inputs 132 may include any type of communication interfaces and/or data input such as Internet protocol (IP) inputs over which streams of television media content are received via communication network 108 and/or IP-based network 124. Media content inputs 132 may include any type of wireless, broadcast, and/or over the air inputs based on which media content is received. Media content 134 can include any type of audio, video and/or image media content (e.g., television programs, programming, commercials, movies, video on demand, music, games, computer-program applications, etc.) received from any type of media content source such as from the content distributor 106. “Other program data” 136 includes, for example, user selection, intermediate results, and/or so on.

FIG. 2 shows an exemplary user interface (UI) 130 for a Social Network Content Driven EPG with the “What's on Now” social network filter having been selected, according to one embodiment. As illustrated, the user selects to view the normal guide content or the social network content with a single selection 202. As shown by 204, the user can determine the type of social content filter that is to be applied to the material being viewed on UI 130. In this example, it is “What's On Now,” although as will be described below, “Everything” and “My Social” are also options for the user to select. In this example of FIG. 2, the “What's On Now” selection shows everything that is on now (e.g., on Thursday June 10 at 7:11 PM) that was deemed by Social Network Content Driven EPG 118 to be part of the user's social circle. For example, the UI 130 shows “American Idol” followed by “John likes this”, “Without a Trace” annotated with “Tim and 8 other people watched this”, “Community” followed by “Julie queued this”, and “Wipeout” indicating that “Nathan watched this.” Accordingly, as indicated in callouts 206 and 208, UI 130 highlights the social content (206) so that the user can identify it easier than the other content being displayed that does not match the filtering criteria (i.e., content 208) selected by the user.

The time frame for “now” in this context of “What's on Now,” is based on the length of the show.” For example, the show “American Idol” is on “now” for one hour, whereas the show “Community” is on “now” but for only one-half an hour. According, the time associated with any particular media content being displayed in this context of “What's on Now” is based on the length of the media content being presented “now.”

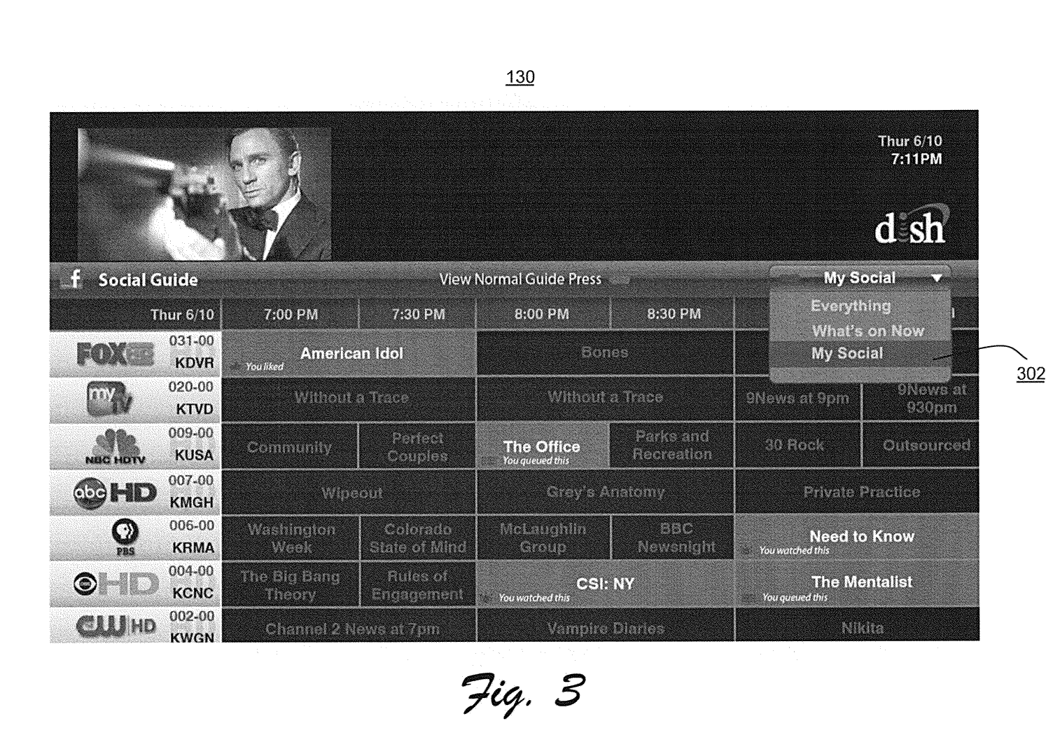

FIG. 3 shows an exemplary UI 130 for a Social Network Content Driven EPG with the “My Social” social network content filter having been selected, according to one embodiment.” As illustrated at 302, the user has selected to filter social network content that is displayed based on “My Social”, meaning that only personal social circle media content is considered for highlighting. In this example, the personal social circled media content is highlighted and includes, for example, “American Idol” indicating “You liked”, “The Office” followed by “You queued this”, “CSI: NY” also indicating “You watched this”, “Need to Know,” also noting “You watched this”, and “The Mentalist,” and noting “You queued this.” In this implementation, please notice that the nonsocial network content information is not highlighted and the social network content information that matches the filter 302 is highlighted.

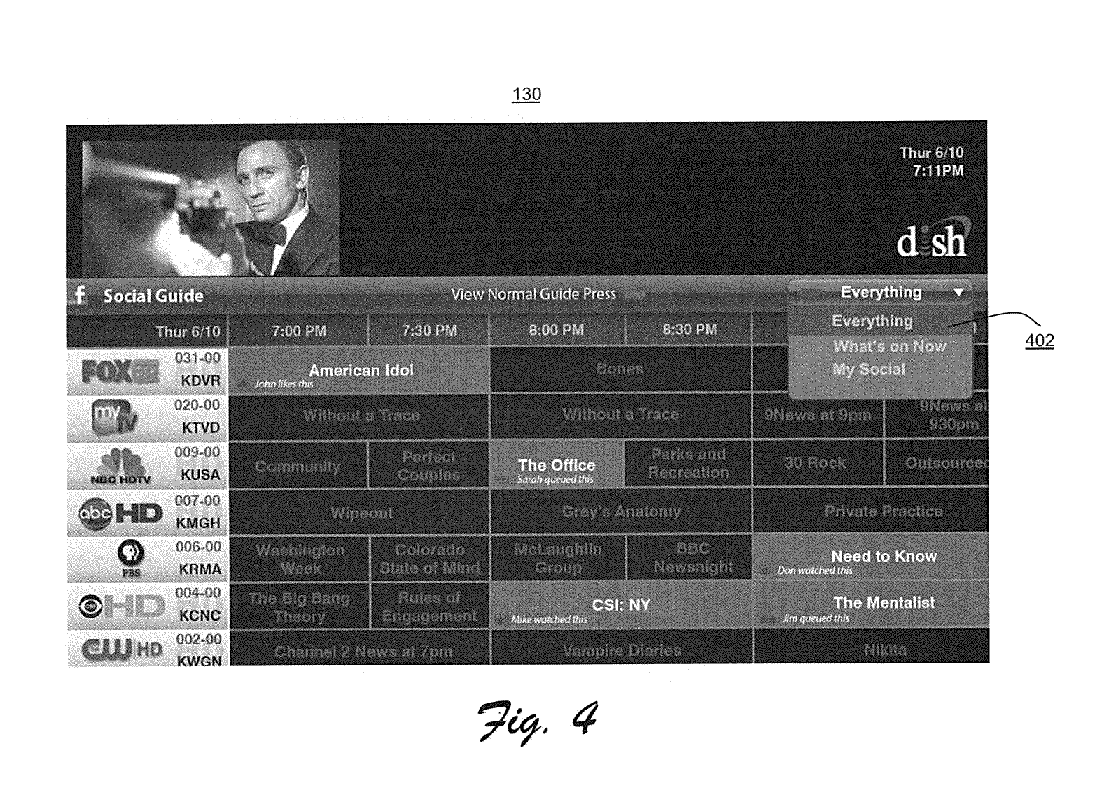

FIG. 4 shows an exemplary UI 130 for a Social Network Content Driven EPG with the “Everything” social content filter having been selected, according to one embodiment. As illustrated at 402, the user has selected to filter social network content that is displayed based on “Everything”, meaning that “Everything” in the user's social circle media content information is highlighted. In this example, the highlighted social circled media content includes, for example, “American Idol” indicating “John like this”, “The Office” followed by “Sarah queued this, “CSI: New York” also indicating “Mike watched this”, “Need to Know “Don watched this”, and “The Mentalist” and noting “Jim queued this.” In this implementation, please notice that the nonsocial network content information is not highlighted and the social network content information that matches the filter 402 is highlighted.

### Exemplary Procedure

Various examples and embodiments of the present disclosure have been described above. Listed and explained below is experimental documentation representing specific applications of the Social Network Content Driven EPG enabled client devices and environment.

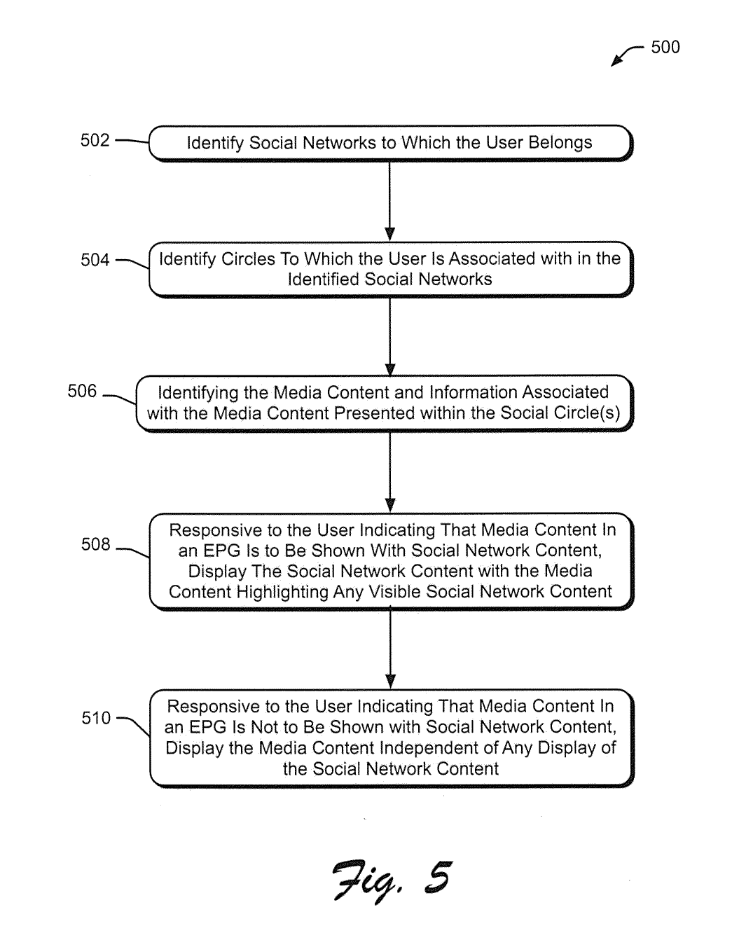

FIG. 5 shows the exemplary procedure 500 for Social Network Content Driven EPG, according to one embodiment. At block 502, Social Network Content Driven EPG determines the social networks to which the user belongs. In one implementation, this is done by an application 118 executing on the client device 102. For example, the application maintains at least a partial list of the social networks to which the user could visit. The application uses an API exported by the social networks to determine whether the user is a member. In another implementation, the application displays a dialog box requesting that the user identify the social networks of interest. In another implementation, the content provider 106 determines the social networks to which the user belongs.

At block 504, system 100 determines the social circle(s) with which the user is associated in the particular identified social network(s). In one implementation, the user provides all of the relevant information to the application for this bullet item and for the previous bullet item (502).

At block 506, Social Network Content Driven EPG queries the social network(s) to obtain information from which to identify media content information presented within the identified social circle(s). For example, in one implementation, an exposed API is used to determine the social circle(s) to which the member belongs as well as the various communications between members of those social circle(s). From this information, it may be possible to obtain information that can be published next to the target media content.

At block 508, Social Network Content Driven EPG responds to a user selecting to mix media content with the social content information gleaned from social networks. This is done according to the user selections in the social network filtering user interface selection tool presented by the EPG program 118 UI 130. If the selection is set to “Everything”, Social Network Content Driven EPG 118 presents a UI 130 that highlights everything associated with the user's social network circles that matches/intersects media content scheduled for presentation by a content provider 106. If the selection is set to “My Social”, Social Network Content Driven EPG 118 presents a User Interface (UI) 130 that highlights only personal social content items that intersect the media content scheduled for presentation by a content provider 106. If the selection is set to “What's on Now”, Social Network Content Driven EPG 118 presents a UI 130 that highlights any media content information associated with the user social network circles that is currently scheduled for play by content provider 106.

At block 510, responsive to user indicating that media content in an EPG is not to be shone with respect to social network content, the media content is displayed independent of any display of the social network content. In other words, social content is not displayed with respect to any one of the exemplary contexts (e.g., Everything, What's on Now, and My Social).

### CONCLUSION

This has been a detailed description of some exemplary embodiments of the present disclosure contained within the disclosed subject matter. The detailed description refers to the accompanying drawings that form a part hereof and which show by way of illustration, but not of limitation, some specific embodiments of the present disclosure, including a preferred embodiment. These embodiments are described in sufficient detail to enable those of ordinary skill in the art to understand and implement the present disclosure. Other embodiments may be utilized and changes may be made without departing from the scope of the present disclosure. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the present disclosure lies in less than all features of a single disclosed embodiment. Thus, the following claims are hereby incorporated into the Detailed Description, with each claim standing on its own as a separate preferred embodiment. It will be readily understood to those skilled in the art that various other changes in the details, material, and arrangements of the parts and method stages which have been described and illustrated in order to explain the nature of this disclosure may be made without departing from the principles and scope as expressed in the subjoined claims.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

What is claimed is:

1. An apparatus comprising:
a processor; and
a memory coupled to the processor, the memory comprising computer program modules with computer program language executable by the processor, the computer program language when executed by the processor operable to perform operations comprising:
receiving input from a user to specify whether media content information presented by an Electronic Programming Guide (EPG) is presented within a context of multiple contexts of one or more social network(s) and corresponding social circle(s) associated with the user; and
responsive to the user input specifying that the EPG present media content within a particular one context of the multiple contexts:
editing any context intersecting media content information with associated information from the social network to personalize the media content information to generate media content information;
outputting the edited media content information highlighted for presentation into the regular grid of the EPG; and
outputting other media content information in the EPG without highlights.

2. The apparatus of claim 1, further comprising, responsive to the user selecting a first context, highlighting for presentation scheduled media content information that is discussed within the one or more social network(s) social circle(s) associated with the user.

3. The apparatus of claim 1, further comprising, responsive to the user selecting a second context, highlighting for presentation scheduled media content information that is scheduled for media content presentation at the present time that intersects media content discussions in the one or more social network(s) social circle(s) associated with the user.

4. The apparatus of claim 1, further comprising, responsive to the user selecting a third context, highlighting for presentation a piece of media content information discussed by the user in the one or more social network(s) social circle(s) associated with the user that is also scheduled for presentation by the media distributor.

5. The apparatus of claim 1 wherein a first context corresponds with a first social network associated with the user and a second context corresponds with a second social network associated with the user, the processor further operable to:
generate the media content information in the first context based on first information associated with the first social network; and
generate the media content information in the second context based on second information associated with the second social network.

6. The apparatus of claim 1, further comprising:
determining the social network(s) and the social circle(s) in the determined social network(s) to which the user belongs; and
identifying the media content information associated with the media content discussed or presented within the social circle(s).

7. The apparatus of claim 1 wherein the media content information includes a title name of associated media content and a configurable amount of any other information associated with the media content obtained from the social network(s).

8. A computer-implemented method comprising:
presenting an electronic program guide (EPG) to a user;
if a user has programmed the EPG to present media content information with respect to a context of multiple contexts of one or more social network(s) social circle(s) associated with the user, highlighting any media content information that is displayed by the EPG based on the context; and
if the user has programmed the EPG not to present any information associated with a social network alongside the media content displayed by the EPG, not highlighting any media content information that is displayed to the user based on any information from a social network.

9. The computer-implemented method of claim 8, further comprising, responsive to a context selection of:
a first context, highlighting for output scheduled media content that is discussed within the one or more social network(s) social circle(s) associated with the user;
a second context, highlighting for output any media content that is scheduled for presentation now that intersects media content discussions in the one or more social network(s) social circle(s) associated with the user; and
a third context, highlighting for output media content presented by the user in the one or more social network(s) social circle(s).

10. The computer-implemented method of claim 8, further comprising:
determining the social network(s) and the social circle(s) in the determined social network(s) to which the user belongs; and
identifying the media content and information associated with the media content presented by members of the social circle(s).

11. The computer-implemented method of claim 8, further comprising:
responsive to the user selecting the context, determining if any media content information to be presented intersects the context; and
if any media content information intersects the context, highlighting the media content information for presentation by the EPG.

12. The computer-implemented method of claim 11 wherein the media content information includes a title name of associated media content and a configurable amount of any other information associated with the media content obtained from the social network(s).

13. A tangible computer-readable media comprising computer-program instructions by a processor, the computer-program instructions when executed by the processor for performing operations comprising:
presenting an electronic program guide (EPG) to a user;
if a user has specified that the information presented by the EPG is presented within a context of multiple contexts of one or more social network(s) social circle(s) associated with the user, highlighting any media content information that is displayed to the user based on the context; and
if the user has programmed the EPG not to present any information associated with a social network alongside the media content displayed by the EPG, not highlighting any media content information that is displayed to the user based on any information from a social network.

14. The tangible computer-readable media of claim 13, further comprising, responsive to the user selecting a first context, highlighting and outputting any and every scheduled media content that is discussed within the one or more social network(s) social circle(s) associated with the user.

15. The tangible computer-readable media of claim 13, further comprising, responsive to the user selecting a second context, highlighting and outputting any and every scheduled media that is scheduled for presentation at the present time that intersects media content discussions in the one or more social network(s) social circle(s) associated with the user.

16. The tangible computer-readable media of claim 13, further comprising, responsive to the user selecting a third context, highlighting and outputting any and every piece of media content discussed by the user in the one or more social network(s) social circle(s) associated with the user that is also scheduled for presentation by the media distributor.

17. The tangible computer-readable media of claim 13, further comprising:
outputting at least one visual representation of at least one member of the social circle(s) in association with a piece of media content information.

18. The tangible computer-readable media of claim 13, further comprising:
determining the social network(s) and the social circle(s) in the determined social network(s) to which the user belongs; and
identifying the media content and information associated with the media content presented within the social circle(s).

19. The tangible computer-readable media of claim 13, further comprising:
responsive to the user selecting the context, determining if any media content information to be presented intersects the context; and
if any media content information intersects the context, highlighting the media content information for presentation in the EPG.

20. The tangible computer-readable media of claim 19 wherein the media content information includes a title name of the media content and a configurable portion of any other information obtained from the social network(s).
